(19) United States
(12) Patent Application Publication
(10) Pub. No.: US 2024/0066779 A1
(43) Pub. Date: Feb. 29, 2024

(54) EXTRUDER HEAD ASSEMBLY WITH QUICK RELEASE DEVICE OF THE EXTRUSION LINE

(71) Applicant: S.T. SOFFIAGGIO TECNICA SRL, Monza (Monza Brianza) (IT)

(72) Inventor: Vladimiro ROTOLO, Monza (Monza Brianza) (IT)

(73) Assignee: S.T. SOFFIAGGIO TECNICA SRL, Monza (Monza Brianza) (IT)

(21) Appl. No.: 18/455,721

(22) Filed: Aug. 25, 2023

(30) Foreign Application Priority Data
Aug. 29, 2022 (IT) 102022000017724

(51) Int. Cl. B29C 48/25; B29C 48/30

(52) U.S. Cl. CPC B29C 48/2562; B29C 48/30

(57) ABSTRACT

An extruder head assembly includes an extruder head having an extrusion line which is inserted in a cylindrical seat formed in said extruder head; the extruder head includes a locking means configured to hold the extrusion line in a working position; the locking means being actuated to release the extrusion line and allow the extraction thereof from the seat. The locking means include dowels that are radially movable between a locking position and a release position, the release position allowing the extraction of the extrusion line.

The present invention relates to an extruder head assembly with a quick release device of the extrusion line.

In the extrusion process, the extrusion line is a nozzle in which the molten or solution polymer is extruded.

US2020101653A1 discloses an extruder having an extruder crosshead, a die, and a die retaining assembly. The extruder crosshead has an annular major surface while the die has a first die surface facing and conformal to that major surface. The die also has a second die surface opposed to the first die surface. The die-retaining assembly is attached to the extruder crosshead, evenly and variably pressing the second die surface with controlled pressure such that the substantially opposing first die surface is pressed into the major surface of the extruder crosshead. The die-retaining also includes movable elements which abut the die in order to move the die.

US2017291364A1 discloses a single screw micro-extruder for a 3D printer including a feed chamber with an opening for receiving solid plastic pellets. An extrusion barrel extends from the feed chamber and has an inner conically shaped bore between input and output ends. The bore has a mouth at the input end and an exit opening at the output end with a melt section therebetween. A rotatable screw is attached to a torque drive of the printer, and extends through the feed chamber and conical bore of the barrel. A constant or tapered diameter of the screw root core, from the input end toward the output end of the barrel, forms a decreasing channel root depth in a helical path for compression between a root core surface and an inner surface of the bore for pressurizing melt in the melt section of the barrel to exit an extrusion nozzle.

U.S. Pat. No. 2,991,504A discloses an adjustable extrusion die mounted in a die holder, the latter being adapted to be removed from and subsequently reinserted into the head structure of an extruder in a definite orientation once the initial adjustment of the die on the die holder has been made to obtain a concentric extrusion about the article. A laterally movable die is supported in a removably fixed die holder having a base and head member positioned about an extrusion core tube. The die is adjusted by two pairs of opposing adjusting screws extending through the head member which is secured to an inner boss of the base member. A clamp ring locks an outer boss of the holder to the extruder to hold the die and die holder in position. The die and holder are removed from the extruder without disturbing the die adjustment by unscrewing the clamp ring and pulling the base member outwardly from the extruder.

The present invention aims at making an extruder head assembly with a quick release device of the extrusion line which allows quickly and easily disassembling and reassembling the extrusion line.

This object and others which are more apparent below are achieved by an extruder head assembly as claimed in the appended claims.

Further features and advantages will become apparent from the description of preferred, but not exclusive, embodiments of the invention, illustrated by way of non-limiting example in the accompanying drawings, in which:

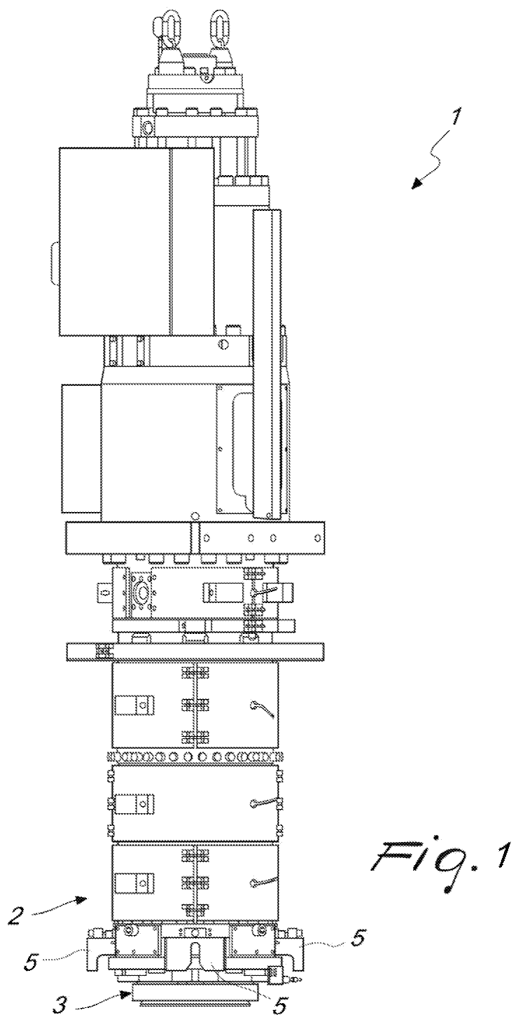

FIG. 1 is a front view of an extruder head having a quick release device of the extrusion line, according to the invention;

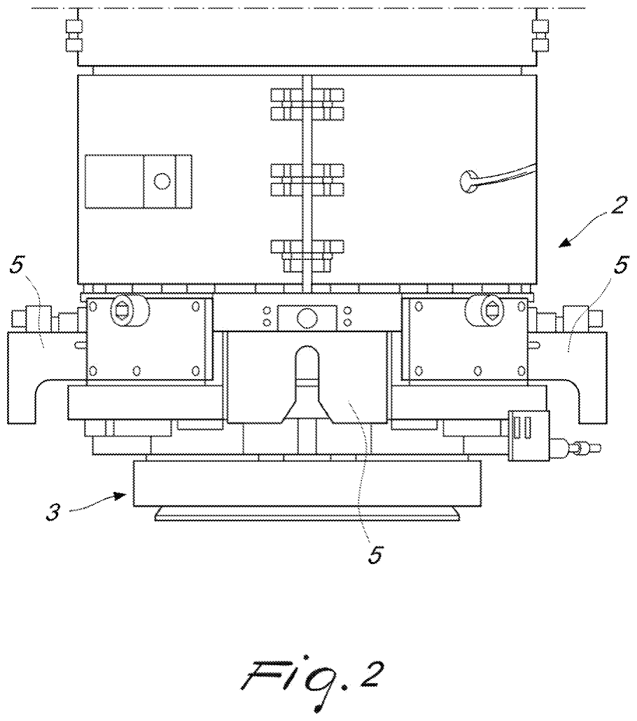

FIG. 2 is an enlarged view of the lower part of the extruder head;

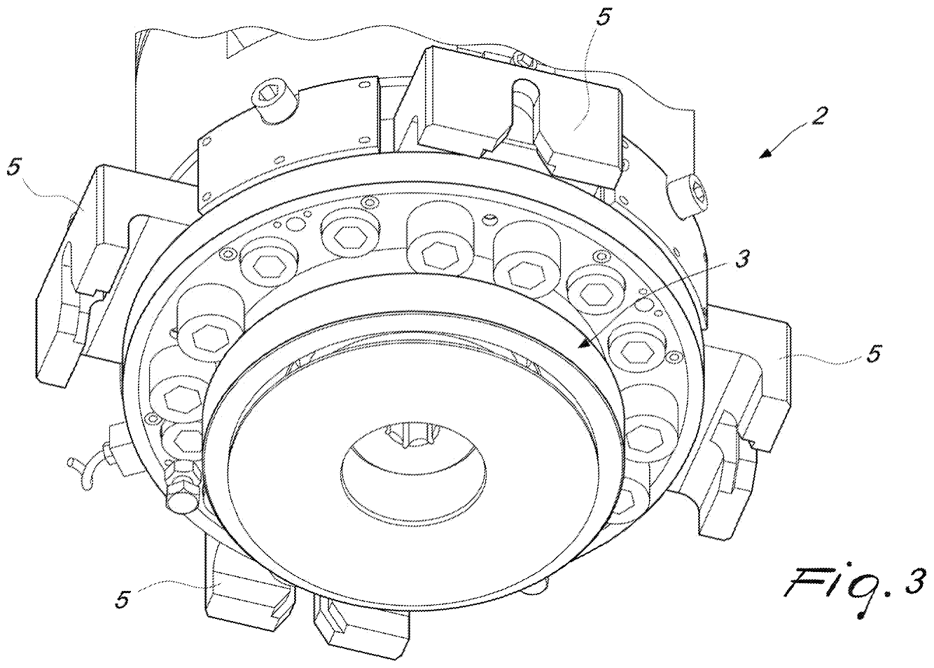

FIG. 3 is a bottom view of the extrusion line;

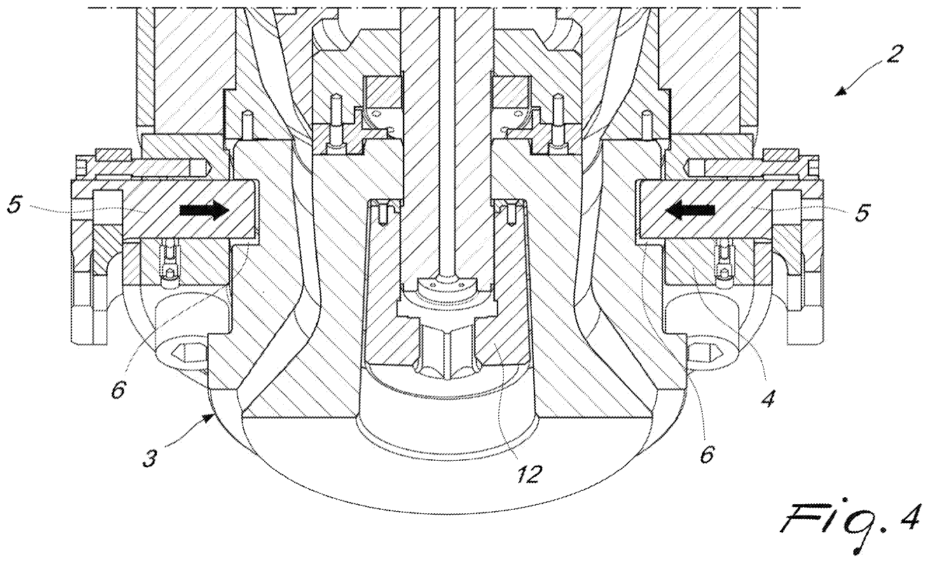

FIG. 4 is a partial section view showing the dowels locking the extrusion line in the working step;

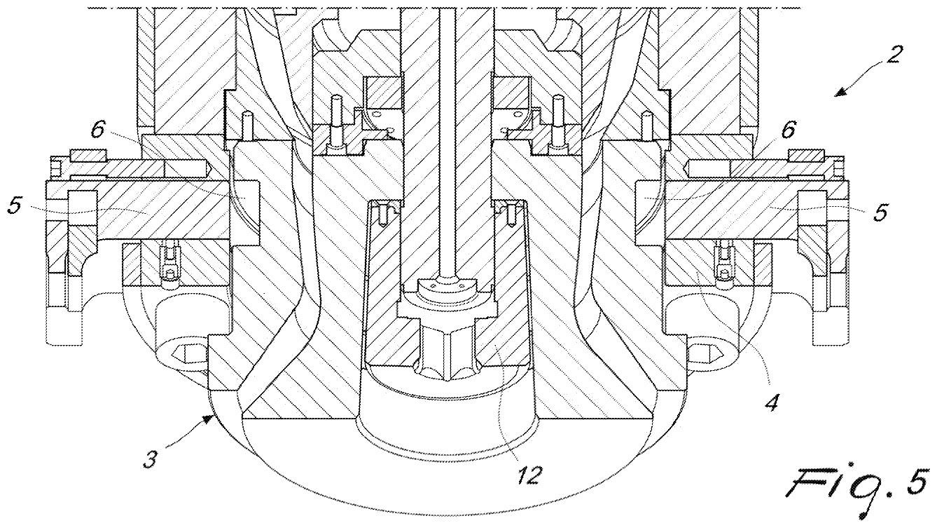

FIG. 5 is a partial section view, similar to the preceding one, showing the step wherein the dowels release the extrusion line in the change step;

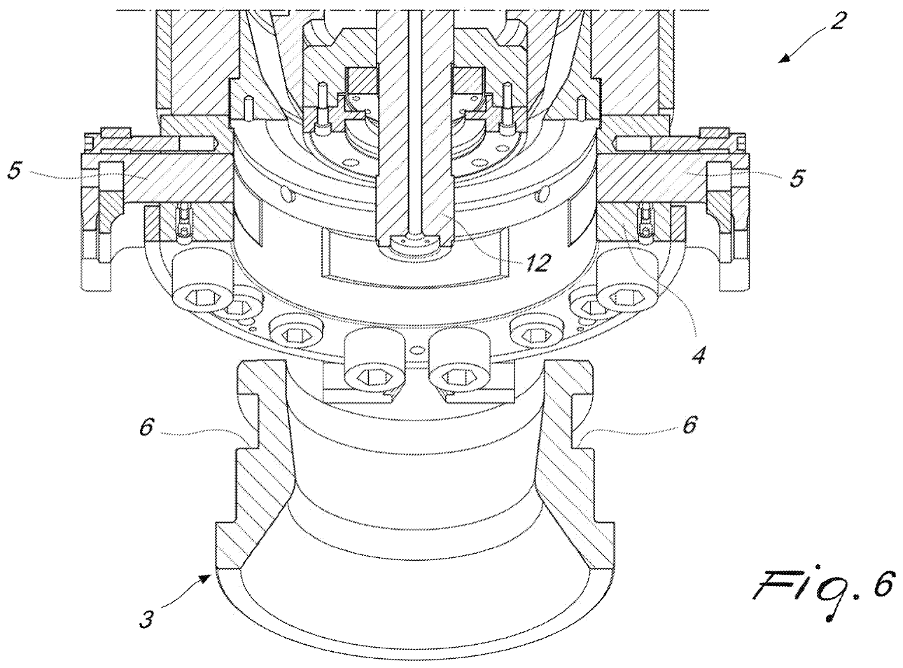

FIG. 6 is a partial section view, similar to the preceding one, showing the extraction step of the extrusion line of the extruder head;

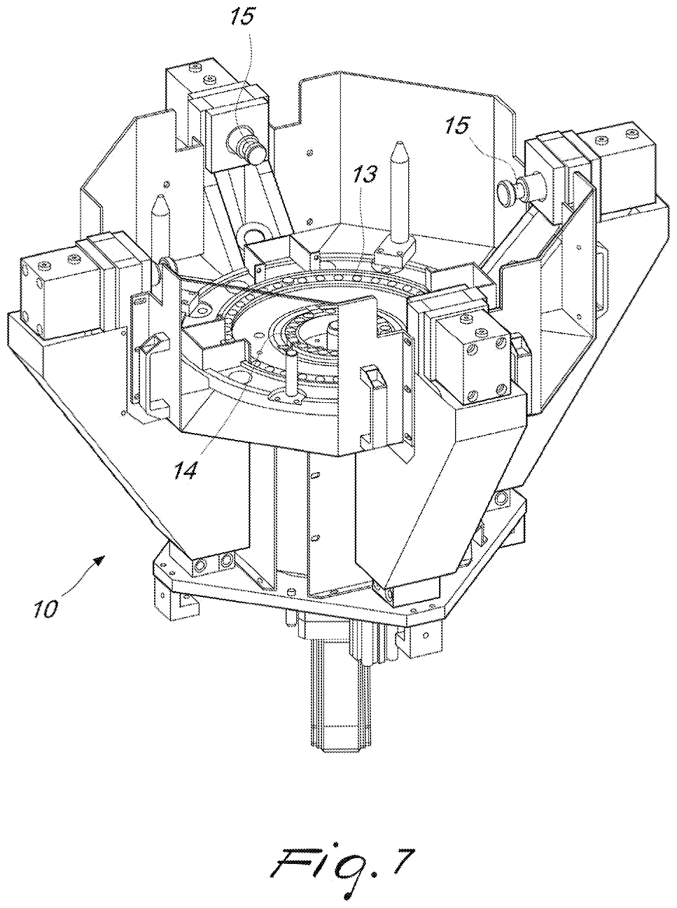

FIG. 7 is a perspective view of the operating apparatus configured to act on the dowels to release the extrusion line;

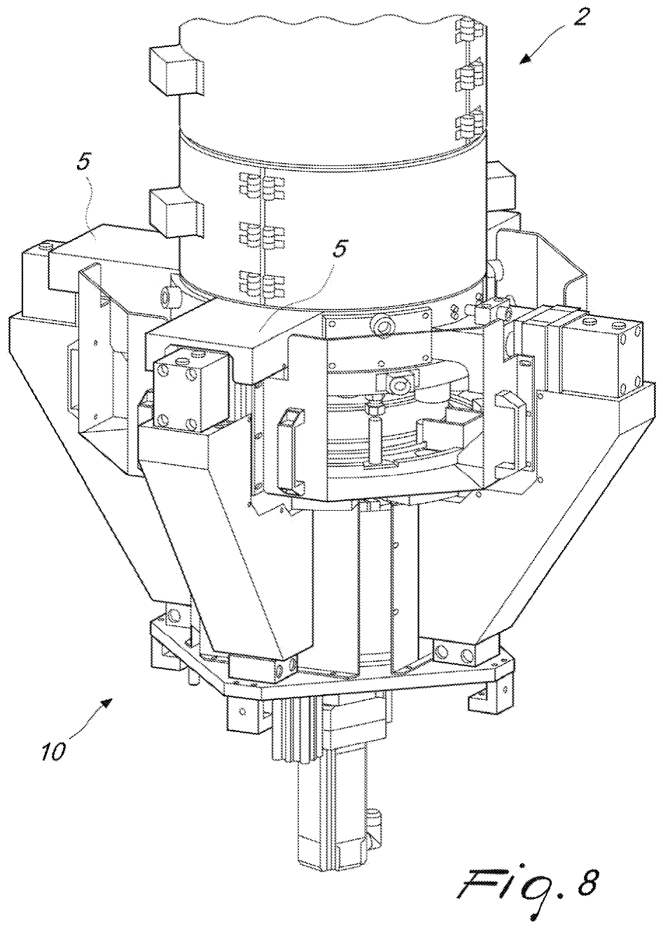

FIG. 8 is a perspective view of the operating apparatus in inserted position in the extruder head;

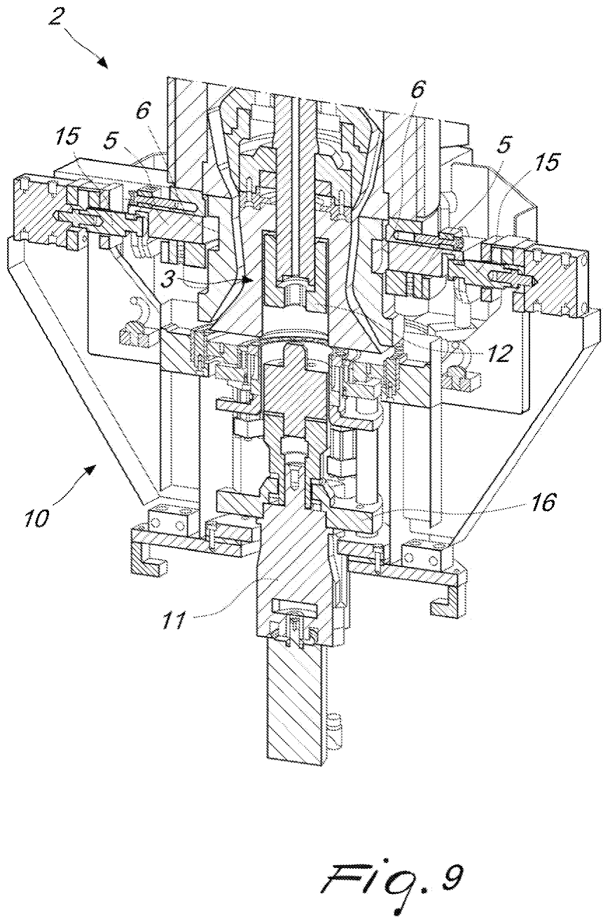

FIG. 9 is a sectional partial section view detailing the various components of the operating apparatus, including the screwdriver which allows the unscrewing/screwing of the locking male threaded flange.

With reference to the figures, the assembly according to the invention, indicated as a whole by reference numeral 1, comprises an extruder head 2 having an extrusion line 3.

The extrusion line 3 is inserted in a cylindrical seat 4 formed in the extruder head 2 which has locking means 5 configured to hold the extrusion line 3 in a working position.

According to the invention, the locking means 5 is actuated to free the extrusion line 3 and allow the extraction thereof from seat 4.

According to a preferred embodiment of the invention, the locking means are dowels 5 radially movable between a locking position, shown in FIG. 4, and a release position, shown in FIGS. 5 and 6, which allows the extraction of the extrusion line 3.

In the locking position, the dowels 5 engage an annular recess 6 formed in the extrusion line 3.

In the embodiment herein shown, there are four dowels 5 arranged at 90° with respect to one another. In other cases of smaller or larger extruder heads, the number of dowels varies, for example from 2 to 8.

According to a further aspect of the invention, the assembly comprises an operating apparatus, indicated as a whole by reference numeral 10, configured to act on the dowels 5 to release the extrusion line 3.

The operating apparatus 10 is shown in FIGS. 7 to 9.

The operating apparatus 10 comprises a screwdriver 11 which allows the unscrewing/screwing of a female threaded flange 12 or in other cases, the male threaded flange itself.

The screwdriver is installed on a movable table 16 which allows the retraction in the unscrewing step and the advancement in the screwing step of the screwdriver itself.

The operating apparatus 10 further comprises two movable tables provided with magnets adapted to fasten and remove the male threaded flange and extrusion line.

More particularly, the operating apparatus comprises an extrusion line movable table 13 and a male threaded flange movable table 14, which are illustrated in FIG. 7.

The dowels 5 are actuated by means of unlocking pins 15, which are mounted on the operating apparatus at the pins themselves.

It was ascertained how the invention achieves the aim and the preset objects.

1. An extruder head assembly, comprising an extruder head having an extrusion line; said extrusion line being inserted in a cylindrical seat formed in said extruder head; a locking means configured to hold said extrusion line in a working position; said locking means being actuated for releasing said extrusion line and allowing the extraction of said extrusion line from said seat; said locking means comprising dowels that are radially movable between a locking position and a release position, said release position allowing the extraction of said extrusion line.

2. The extruder head assembly, according to claim 1, wherein, in said locking position, said dowels engage a respective annular recess formed in said extrusion line.

3. The extruder head assembly, according to claim 1, wherein said locking means comprises four dowels arranged at 90° relative to one another.

4. The extruder head assembly, according to claim 1, comprising an operating apparatus that operates said dowels in order to release said extrusion line.

5. The extruder head assembly, according to claim 4, wherein said operating apparatus comprises a screwdriver that allows the unscrewing/screwing of a female threaded flange.

6. The extruder head assembly, according to claim 4, wherein said operating apparatus comprises a screwdriver that allows the unscrewing/screwing of a male threaded flange.

7. The extruder head assembly, according to claim 4, wherein said operating apparatus comprises two movable tables provided with magnets adapted to fasten and extract said male threaded flange and said extrusion line.

8. The extruder head assembly, according to claim 4, wherein said operating apparatus comprises an extrusion line movable table and a male threaded flange movable table.

9. The extruder head assembly, according to claim 4, wherein said operating apparatus comprises unlocking pins; said dowels being driven by means of said unlocking pins.
